(19) United States
(12) Patent Application Publication
(10) Pub. No.: US 2026/0311265 A1
(43) Pub. Date: Oct. 8, 2026

(54) TAXONOMY EXTRACTION USING AN LLM

(71) Applicant: INTUIT INC., Mountain View, CA (US)

(72) Inventors: John SAMUEL, Bangalore (IN); Vishal Kumar SINGH, Bangalore (IN); Ashwin Kamath B, Bangalore (IN); Kartik TRIPATHI, Bangalore (IN)

(73) Assignee: INTUIT INC., Mountain View, CA (US)

(21) Appl. No.: 19/170,027

(22) Filed: Apr. 3, 2025

(51) Int. Cl. G06Q 40/10; G06F 18/241

(52) U.S. Cl. CPC G06Q 40/10; G06Q 40/123

(57) ABSTRACT

A method for processing tax return data. A processing server receives tax return data in a structured format that includes a schema defining the tax return data. The processing server extracts features from the tax return data according to the schema. The processing server classifies these extracted features using a machine learning model, and a large language model (LLM) also classifies the extracted features. The system analyzes the classified data from both models to generate a hierarchical taxonomy of the tax return data, organizing it into categories and subcategories. The LLM analyzes this hierarchical taxonomy of the tax return data. The system displays the generated taxonomy to a user through an interactive interface, allowing for intuitive navigation and exploration of the tax return information.

### BACKGROUND

Many kinds of data processing and analysis have traditionally relied on manual methods or basic software solutions to extract and categorize information. For example, tax return processing systems typically involve accountants manually reviewing tax documents, identifying categories of information, and generating basic taxonomies to summarize the data. Some software solutions have emerged that use predefined topics and static logic to organize tax return data, while others can extract specific data points from PDF documents and identify potential tax credits and deductions.

However, these existing approaches often fall short in several areas. Manual methods are time-consuming and prone to errors, especially when dealing with complex tax returns. Basic software solutions lack the ability to adapt to new tax regulations or unique financial situations, often requiring frequent updates and manual interventions. Most current systems do not employ advanced machine learning techniques to identify patterns and generate comprehensive taxonomies for entire tax returns, limiting their ability to provide deep insights and automate complex analysis tasks. This results in inefficiencies in tax preparation and auditing processes, particularly when dealing with individuals or businesses with intricate financial structures.

### SUMMARY

Embodiments disclosed herein solve the aforementioned technical problems and may provide other technical solutions as well. Contrary to conventional techniques, the disclosed solution includes a novel method and system for implementing a framework for extracting a meaningful taxonomy from complex data sources such as tax returns using a Large Language Model (LLM). In some embodiments, the system preprocesses tax return data in JavaScript Object Notation (JSON) format, extracts relevant features, and uses a trained LLM to classify the data into categories such as Income, Deductions, Credits, and Tax Liability. The LLM is integrated into the tax return process to prompt for credits and deductions. The extracted taxonomy is presented through a user-friendly interface, allowing accountants to quickly identify areas and potential compliance issues. This approach aims to increase the efficiency and accuracy of tax preparation and auditing compared to existing manual methods or static logic systems. The use of an LLM generates a comprehensive taxonomy of the entire tax return.

An example embodiment includes a method for processing tax return data, comprising receiving, by a processing server, tax return data in a structured format comprising a schema defining the tax return data, extracting, by the processing server, features from the tax return data according to the schema, classifying, by the processing server, the extracted features using a machine learning model, classifying, by a large language model (LLM), the extracted features, analyzing the classified data from the machine learning model and the LLM to generate a hierarchical taxonomy of the tax return data sorted into categories and subcategories, analyzing, by the LLM, the hierarchical taxonomy of the tax return data, and displaying, by the LLM, the generated taxonomy to a user through an interactive interface.

An example embodiment includes a system for processing tax return data, comprising a processing server configured to receive tax return data in a structured format comprising a schema defining the tax return data, extract features from the tax return data according to the schema; classify the extracted features using a machine learning model, classifying, by a large language model (LLM), the extracted features, analyze the classified data from the machine learning model and the LLM to generate a hierarchical taxonomy of the tax return data sorted into categories and subcategories, analyze the hierarchical taxonomy of the tax return data, and a display device configured to display the generated taxonomy to a user through an interactive interface.

### BRIEF DESCRIPTION OF THE DRAWINGS

So that the present disclosure can be understood in detail, a more particular description of the disclosure, briefly summarized above, may be made by reference to example embodiments, some of which are illustrated in the appended drawings. It is to be noted, however, that the appended drawings illustrate only example embodiments of this disclosure and are therefore not to be considered limiting of its scope, for the disclosure may apply to other equally effective example embodiments.

FIG. 1 illustrates a system for processing and analyzing data, according to aspects of the present disclosure.

FIG. 2 illustrates a system for processing data, according to an embodiment.

FIG. 3 illustrates a flowchart of a method for processing data and generating a taxonomy, in accordance with example embodiments.

FIG. 4 illustrates a flowchart of a method for processing data, according to aspects of the present disclosure.

FIG. 5 illustrates a flowchart of a method for feature extraction from data, according to an embodiment.

FIG. 6 illustrates a flowchart of a method for machine learning classification of data, in accordance with example embodiments.

FIG. 7 illustrates a flowchart of a method for analyzing data using a Large Language Model, according to aspects of the present disclosure.

FIG. 8 illustrates a flowchart of a method for combining the outputs of the ML model and the LLM to generate the taxonomy, according to aspects of the present disclosure

FIG. 9 illustrates a block diagram of a computing system, according to an embodiment.

### DETAILED DESCRIPTION OF SEVERAL EMBODIMENTS

The present disclosure relates to systems and methods for processing data using advanced machine learning techniques, particularly leveraging the power of LLMs. To illustrate the features and functionality of the present systems and methods, the following disclosure presents examples wherein tax return data is processed. When used to process tax return data, for example, this innovative approach enhances the efficiency and accuracy of tax return analysis, providing substantial benefits to tax professionals and taxpayers alike.

For example, the disclosed embodiments may provide a framework for extracting a meaningful taxonomy from complex tax returns using an LLM. The system may utilize a tax return dataset with a fixed schema containing taxpayer data and tax information. An LLM, trained on a large dataset of tax returns, may be employed to identify and classify data within the tax return into categories such as Income, Deductions, Credits, and Tax Liability. The framework may include a taxonomy algorithm that involves data preprocessing, feature extraction, classification, and taxonomy generation. The system may also incorporate an integration between the LLM model and the tax return process to prompt for credits and deductions. An output mechanism may present the extracted taxonomy to the user, allowing accountants to quickly identify areas of interest and potential compliance issues. This approach may increase the efficiency and accuracy of tax preparation and auditing, making it easier for accountants to analyze and understand even the most complex tax returns.

By utilizing a combination of data processing, feature extraction, and machine learning classification, the system may transform complex tax return data into a comprehensive, hierarchical taxonomy. This taxonomy may organize tax information into easily navigable categories and subcategories, allowing for quick identification of financial elements, potential deductions, and areas requiring further attention.

One of the primary advantages of this system may be its ability to handle large volumes of tax data with increased speed and precision compared to traditional manual methods. The use of LLMs may enable the system to understand and interpret complex tax regulations and apply them accurately to individual tax situations. This may result in more thorough and consistent tax return analyses, potentially reducing errors and identifying opportunities for tax savings that might otherwise be overlooked.

Consider a real-world scenario where a certified public accountant (CPA) is tasked with reviewing hundreds of complex tax returns for a large accounting firm. Traditionally, this process would involve hours of manual review for each return, with a high risk of human error or oversight. With the present disclosure, the CPA may upload the tax return data into the system, which may then process and analyze the information using its advanced algorithms and LLM capabilities.

Within minutes, the system may generate a detailed taxonomy of each tax return, highlighting important elements such as unusual income sources, potential deductions, and areas that may require additional documentation. The CPA may then use the interactive interface to quickly navigate through the organized data, focusing their expertise on important aspects of each return. This may not only save significant time but may also improve the quality and consistency of the tax review process.

The system may comprise a processing server for initial data handling and feature extraction, a LLM for advanced analysis, taxonomy generation, and a display device for presenting the results through an intuitive, interactive interface. This combination of components may work seamlessly together to transform raw tax data into actionable insights, revolutionizing the way tax professionals approach their work and potentially leading to better outcomes for taxpayers.

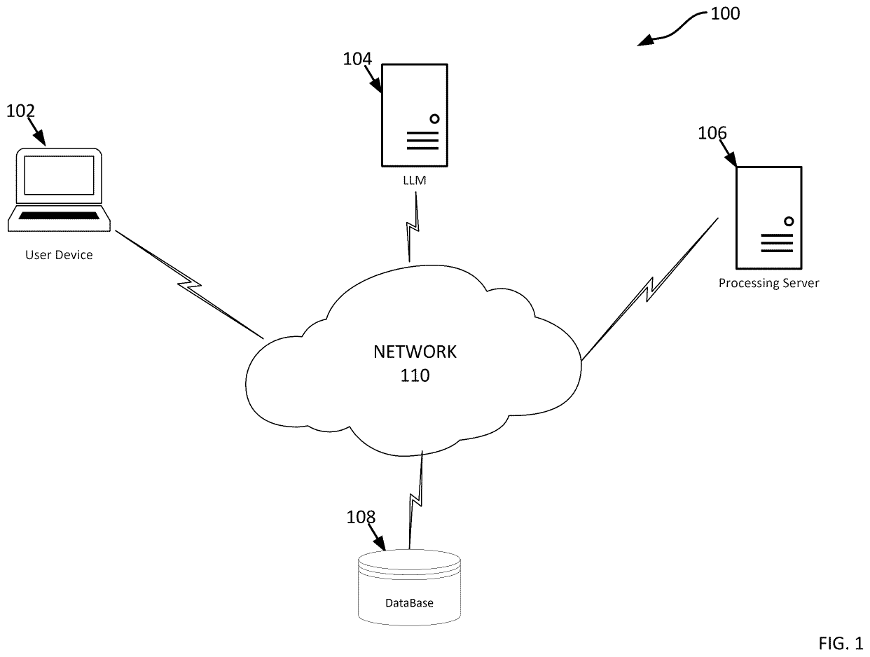

FIG. 1 illustrates a system 100 that may be used for processing and analyzing tax return data, for example. The system 100 may include a client device 102, an LLM server 104, a processing server 106, a database 108, and a communication network 110. These components may work together to provide efficient and accurate tax return processing and analysis in some embodiments.

The client device 102 may be a computer, smartphone, tablet, or any other device capable of connecting to the communication network 110. A user, such as an accountant or taxpayer, may use the client device 102 to input tax return data and receive processed results.

The LLM server 104 may host an LLM. In the tax return example, the LLM may be trained on tax-related data. This server may be responsible for analyzing the processed tax return data and generating comprehensive taxonomies. In some cases, the LLM server 104 may continuously improve its performance through ongoing learning and retraining on new tax return data.

The processing server 106 may handle data preprocessing, feature extraction, and initial machine learning tasks. This server may work in conjunction with the database 108 to store and retrieve tax return data, as well as historical data used for training and improving the system over time.

The database 108 may store various types of data, including raw tax return information, processed results, and training data for the machine learning models. In some cases, the database 108 may be used to maintain a record of system improvements over time.

The communication network 110 may facilitate data exchange between components of the system 100. This network may be the internet, a local area network, or any other suitable communication infrastructure.

In operation, a user may submit tax return data through the client device 102. The data may be transmitted via the communication network 110 to the processing server 106. The processing server 106 may preprocess the data and extract relevant features, storing intermediate results in the database 108. The processed data may then be sent to a machine learning model (ML) running on the processing server 106 and to an LLM model running on the LLM server 104 for classifications which are then used for taxonomy generation.

During the tax return preparation phase, the system 100 may prompt the user for credits and deductions. This proactive approach may help ensure that relevant information is captured and considered in the analysis.

Once the LLM server 104 completes its analysis, the results may be sent back through the communication network 110 to the client device 102 for display to the user. The user may then interact with the generated taxonomy, exploring different categories and subcategories of their tax return data.

For example, an accountant may use the system 100 to process a complex tax return for a client. The accountant may input the client's tax data through their laptop (client device 102). The processing server 106 may clean and organize the data, while the processing server 106 and LLM server 104 both analyze the data to perform classifications which are used to generate a comprehensive taxonomy. The accountant may then receive an interactive display of the tax return structure, allowing them to quickly identify potential deductions, verify income sources, and ensure compliance with tax regulations. This process may significantly reduce the time the accountant spends on manual review, allowing her to focus on providing valuable insights to her client.

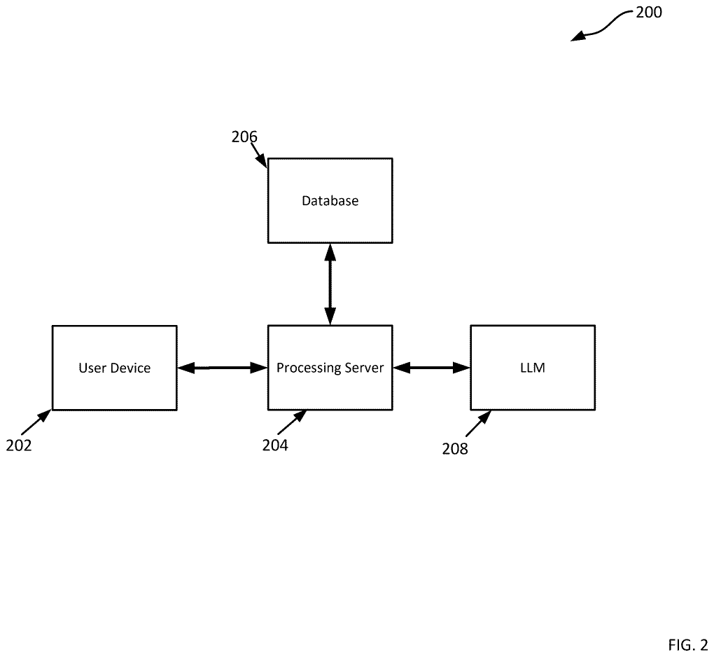

FIG. 2 illustrates a system 200, showing communication flow of the system. The system 200 may include a client device 202, a processing server 204, a database 206, and an LLM server 208. These components may work together to process and analyze tax return data, generating comprehensive taxonomies and insights.

The devices shown in FIG. 2 correspond to those depicted in FIG. 1, with each component serving similar functions in both systems. The client device 202 in FIG. 2 may be analogous to the client device 102 in FIG. 1, serving as the user interface for inputting tax return data and receiving processed results. The processing server 204 in FIG. 2 may perform similar tasks to the processing server 106 in FIG. 1, handling data preprocessing and feature extraction. The database 206 in FIG. 2 may function similarly to the database 108 in FIG. 1, storing various types of data including raw tax return information and processed results. The LLM server 208 in FIG. 2 may correspond to the LLM server 104 in FIG. 1, hosting an LLM for advanced analysis for classification. While FIG. 2 does not explicitly show a communication network, the interconnections between components may imply a similar network infrastructure to the communication network 110 depicted in FIG. 1, facilitating data exchange between components of the system.

In a use case, a tax professional may upload a complex tax return to the system 200 through the client device 202. The tax return data, structured in JSON format, may be sent to the processing server 204. The processing server 204 may preprocess the data, extract relevant features, and perform classification using machine learning techniques.

The tax return data, structured in JSON format, may be sent to the processing server 204 through a secure data transmission protocol, such as HTTPS. The JSON format may provide a lightweight, human-readable, and machine-parsable structure for representing complex tax return information. This format may allow for efficient organization of various tax data elements, including taxpayer information, income sources, deductions, credits, and other relevant financial details.

For example, a simplified JSON structure for a tax return may look like this:

“taxpayer”: {
“name”: “John Doe”,
“ssn”: “123-45-6789”,
“filingStatus”: “single”
},
“income”: {
“wages”: 75000,
“interest”: 1200,
“dividends”: 3500
},
“deductions”: {
“standardDeduction”: 12550,
“itemizedDeductions”: {
“stateTaxes”: 5000,
“propertyTaxes”: 3000,
“charitableContributions”: 2000
}

When this JSON data is sent to the processing server 204, the server may parse the structure, extracting relevant information for further processing and analysis. The use of a standardized JSON schema may allow the processing server 204 to efficiently handle various types of tax returns, from simple individual returns to complex business filings, while maintaining a consistent data structure for subsequent processing steps.

The data may also be sent to the LLM server 208 for in-depth analysis and classification.

The LLM server 208 may analyze the data, comparing the data to patterns identified in historical tax returns stored in the database 206. For instance, the LLM may recognize that the ratio of charitable contributions to total income is higher than average for this tax bracket. The LLM may also identify that the taxpayer may be eligible for additional deductions based on their profession or location.

As the LLM server 208 processes the data, the LLM server 208 may store intermediate results in the database 206. These results may include partial taxonomies, confidence scores for various classifications, and potential areas for further investigation.

The final generated taxonomy may look something like this:

“income”: {
“employment”: {
“wages”: 75000
},
“investments”: {
“interest”: 1200,
“dividends”: 3500
}
},
“deductions”: {
“itemized”: {
“taxes”: {
“stateTaxes”: 5000,
“propertyTaxes”: 3000
},
“charitableContributions”: 2000
}
},
“potentialDeductions”: [
“homeOfficeDeduction”,
“professionalDevelopmentExpenses”
],
“auditRiskAreas”: [
{
“category”: “charitableContributions”,
“reason”: “Higher than average for income bracket”
}
]

Throughout this process, the database 206 may be accessed to store intermediate results and retrieve relevant historical data. The generated taxonomy may then be sent back to the client device 202 for display to the tax professional through an interactive interface. The interface may allow the tax professional to explore different categories, expand or collapse sections, and view detailed information about specific items, while also highlighting areas that require additional attention or documentation, such as the potentially high charitable contributions or the suggested additional deductions.

This communication flow may involve multiple data exchanges between components. For example, the processing server 204 may send queries to the database 206 to compare extracted features against historical patterns. The LLM server 208 may request additional context from the processing server 204 to refine its analysis. The client device 202 may send user feedback on the generated taxonomy back to the processing server 204, which may then update the database 206 and inform the LLM server 208 to improve future analyses. This iterative communication process may allow the system to continuously refine and improve its tax return processing capabilities.

This system 200 may significantly streamline the tax return analysis process, allowing tax professionals to quickly identify aspects of complex returns and focus their expertise where it is needed. The use of structured data formats like JSON, combined with advanced processing and LLM capabilities, may enable more accurate and comprehensive tax return analyses than traditional manual methods.

The system may employ a dual-model approach for classifying tax return data, utilizing both a machine learning (ML) model and a large language model (LLM) that operate in parallel. This parallel processing architecture directly addresses the technical problem of efficiently processing complex, multi-format tax data that traditional single-model systems struggle to handle. By distributing computational tasks across specialized models, the system significantly reduces processing time while maintaining high accuracy. The ML model, which may be a specialized neural network such as an LSTM, may focus on identifying patterns and relationships within structured numerical data. Meanwhile, the LLM may excel at understanding and interpreting unstructured textual information and complex tax regulations.

By running these models concurrently, the system may leverage the strengths of both approaches to overcome the technical limitations of single-model systems. This practical application solves the technical problem of data heterogeneity in tax returns, where information exists in multiple formats that no single algorithm can optimally process. The outputs from one or both models may then be used to generate the final taxonomy. In some cases, the system may combine the classifications from both models, potentially weighting them based on their respective confidence scores or the specific aspects of the tax return being analyzed. This approach may result in a more robust and accurate categorization of tax return elements while reducing computational overhead and memory requirements compared to more generalized approaches.

The system may also incorporate a feedback loop mechanism to continuously improve the performance of both the ML and LLM models. After generating the taxonomy, the system may analyze the outputs of both models along with their associated confidence scores. This analysis may help identify areas where one model outperforms the other or where both models struggle with certain types of data. Based on this assessment, the system may update one or both models. For instance, if the ML model consistently achieves higher confidence scores for classifying numerical data, the system may prioritize its output for those categories in future analyses. Conversely, if the LLM demonstrates superior performance in interpreting complex deductions, its classifications may be given more weight in those areas. This ongoing refinement process represents a practical application that solves the technical problem of static model performance, allowing the system to adapt to new tax regulations, evolving financial instruments, and changing patterns in tax return data, potentially leading to increasingly accurate and insightful analyses over time while optimizing computational resource allocation.

This system presents a practical application for solving the technical problem of efficiently processing complex, multi-format tax data by employing a dual-model approach with parallel processing. It addresses the challenge of data heterogeneity in tax returns by utilizing both a machine learning model (specialized for structured numerical data) and a large language model (adept at interpreting unstructured text and complex regulations) concurrently. This architecture overcomes the limitations of single-model systems, reducing processing time while maintaining high accuracy. The system combines outputs from both models, potentially weighting them based on confidence scores, to generate a more robust and accurate taxonomy. Furthermore, it incorporates a feedback loop mechanism that continuously analyzes model performance and adjusts their relative weights, allowing the system to adapt to new tax regulations, evolving financial instruments, and changing data patterns. This ongoing refinement process solves the technical problem of static model performance, optimizing computational resource allocation and leading to increasingly accurate and insightful analyses over time. By effectively handling diverse data formats and adapting to changes in the tax landscape, this practical application significantly enhances the efficiency and accuracy of tax return processing and analysis.

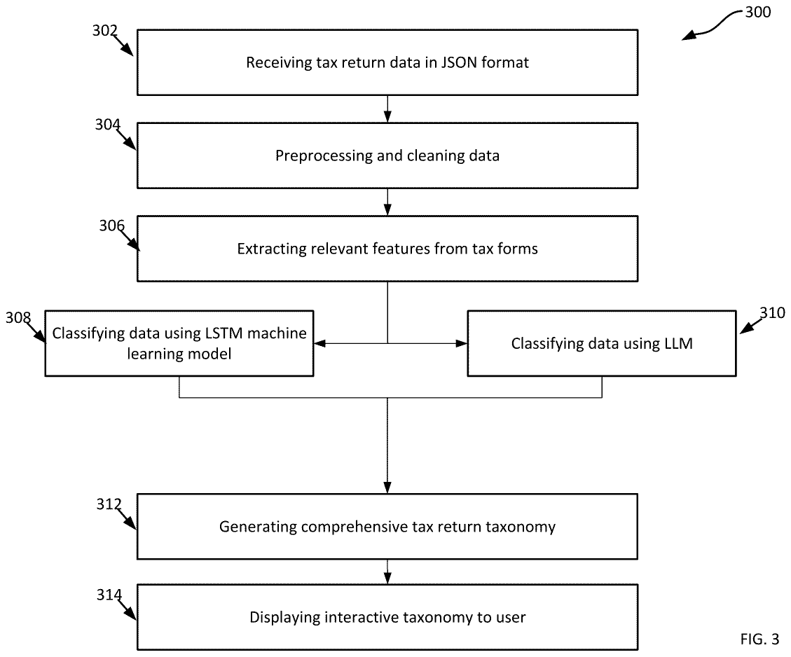

The following figures, FIG. 3 through FIG. 7, illustrate various methods and processes that may be performed by the system described above. These figures provide detailed flowcharts that outline the steps involved in processing tax return data, extracting relevant features, classifying the data using machine learning techniques, and generating a comprehensive taxonomy using an LLM. The methods depicted in these figures may work in concert to create a powerful and efficient tax return analysis tool that may significantly enhance the capabilities of tax professionals and improve outcomes for taxpayers.

FIG. 3 illustrates a flowchart of a method 300 for processing tax return data and generating a taxonomy. The method 300 in FIG. 3 may comprise processing performed by system 200 such as receiving tax return data (302), preprocessing and cleaning the data (304), extracting relevant features (306), classifying features using a machine learning model (308), classifying features using a trained LLM (310), generating a comprehensive tax return taxonomy (312) based on the classifications, and displaying the interactive taxonomy to the user (314).

The system 200 may begin at 302 with receiving tax return data in a structured format. In some cases, the processing server 106 may receive the tax return data from the client device 102 via the communication network 110. The structured format may comprise a schema defining the tax return data. For example, the tax return data may be in a JSON format with a predefined structure that outlines various tax-related fields and their relationships.

At 304, system 200 may perform preprocessing and cleaning of the received tax return data. The processing server 106 may perform various operations to ensure the data is in a suitable format for further analysis. These operations may include removing null or empty fields, standardizing date formats, and handling missing data through imputation or flagging.

At 306, system 200 may extract relevant features from the tax forms. The processing server 106 may analyze the preprocessed data and identify information based on the schema. For example, the processing server 106 may extract data on wages, medical expenses, mortgage interest, and other important variables that are relevant for tax calculations and analysis.

At 308, system 200 may classify the extracted features using a machine learning model. The processing server 106 may employ a trained machine learning model, such as a Long Short-Term Memory (LSTM) neural network, to categorize the extracted features into specific tax-related categories. This classification may help organize the data into a structured format that can be further analyzed.

At 310, system 200 may classify the extracted features using a trained LLM. The LLM server 104 may process the data to identify patterns, relationships, and insights within the tax return information. The LLM may be capable of understanding complex tax regulations and applying them to the specific tax situation represented by the data.

At 312, system 200 may generate a comprehensive tax return taxonomy based on the analyzed data. The LLM server 104 may create a hierarchical structure that organizes the tax return information into categories and subcategories. For example, the taxonomy may include broad categories such as Income, Deductions, Credits, and Tax Liability, with more specific subcategories under each main category.

At 314 system 200 may display the interactive taxonomy to the user. The client device 102 may receive the generated taxonomy from the LLM server 104 via the communication network 110 and present the taxonomy through an interactive interface. This interface may allow users to navigate through the hierarchical structure, drill down into specific categories, and view detailed information about various aspects of the tax return.

In the context of the accountant using the system 100 to process a complex tax return for a client, system 200 in FIG. 3 may unfold as follows: At 302, the accountant may upload the client's tax return data through their laptop (client device 102) in a structured JSON format. At 304, the processing server 106 may clean and preprocess this data, standardizing formats and handling any missing information from the complex return. 306 may involve the processing server 106 extracting relevant features from the client's tax data, such as multiple income sources, investment details, and various deductions. At 308, these extracted features may be classified into specific tax categories using a machine learning model, potentially identifying unique aspects of the client's financial situation. At 310, the LLM server 104 may also classify the data, applying its understanding of complex tax regulations to the client's specific circumstances. At 312, the LLM server 104 may generate a comprehensive taxonomy of the client's tax return, organizing the complex financial information into a clear, hierarchical structure. In 314, this interactive taxonomy may be displayed on the accountant's laptop, allowing them to quickly navigate through the client's complex tax situation, identify potential deductions, verify income sources, and ensure compliance with tax regulations applicable to individuals.

At 302, the system may receive tax return data in formats such as JSON, extended markup language (XML), or CSV, utilizing schemas like XML schema definition (XSD) or JSON Schema for validation. 304 may employ data cleaning algorithms such as regular expressions for standardization, k-nearest neighbors for imputation of missing values, or outlier detection using Isolation Forests. For feature extraction in 306, techniques like Principal Component Analysis (PCA), t-SNE, or uniform manifold approximation and projection (UMAP) may be used to reduce dimensionality and identify features. 308 may utilize machine learning models such as LSTM networks, Random Forests, or Support Vector Machines (SVM) for classification tasks. At 310, the system may employ LLMs like GPT-3, BERT, or T5 for advanced analysis, potentially using techniques such as few-shot learning or prompt engineering. 312 may involve hierarchical clustering algorithms like Hierarchical Density-Based Spatial Clustering of Applications with Noise (HDBSCAN) or agglomerative clustering to generate the taxonomy structure, possibly utilizing graph algorithms like PageRank for identifying important categories. 314 may use data visualization libraries such as D3.js, Plotly, or Highcharts to create interactive, hierarchical visualizations, potentially employing WebGL for handling large datasets efficiently.

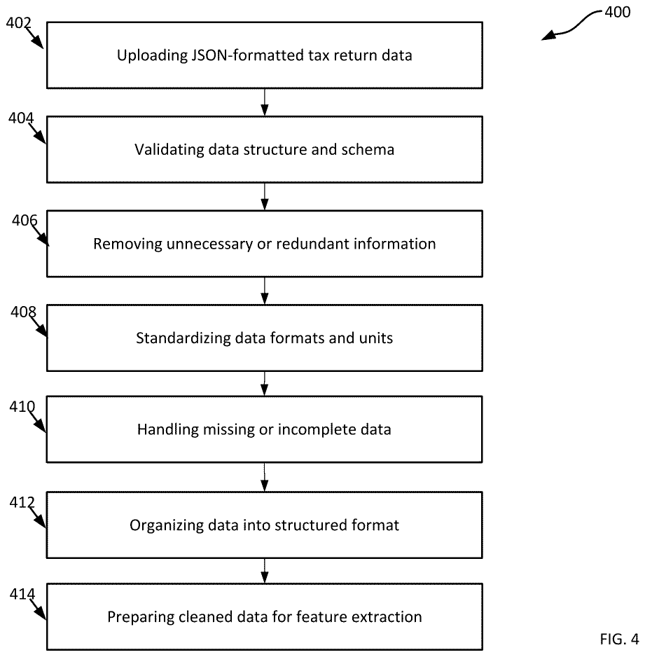

FIG. 4 illustrates a flowchart of a method 400 for processing tax return data. The method 400 in FIG. 4 may comprise processing performed by system 200 such as uploading JSON-formatted tax return data (402), validating the data structure and schema (404), removing unnecessary or redundant information (406), standardizing data formats and units (408), handling missing or incomplete data (410), organizing the data into a structured format (412), and preparing the cleaned data for feature extraction (414).

At 402, the system 200 may begin with uploading JSON-formatted tax return data. In some cases, the client device 202 may transmit the tax return data to the processing server 204 via the communication network 110. The JSON format may provide a structured and standardized way to represent complex tax return information, making it easier for the processing server 204 to parse and process the data.

The system 200 may continue processing at 404, where the processing server 204 may validate the data structure and schema of the received tax return data. This validation process may ensure that the uploaded data conforms to the expected format and contains beneficial fields. For example, the processing server 204 may check that fields such as taxpayer identification number, income sources, and deduction categories are present and properly formatted. If any discrepancies are found, the processing server 204 may flag these issues for further review or correction.

At 406, the system 200 may remove unnecessary or redundant information from the tax return data. The processing server 204 may identify and eliminate duplicate entries, irrelevant metadata, or any other extraneous information that could potentially interfere with subsequent analysis. This may help streamline the data and improve the efficiency of later processing stages.

The system 200 may proceed to 408, where the processing server 204 may standardize data formats and units. This may be beneficial for ensuring consistency across different tax returns and facilitating accurate comparisons and calculations. For instance, the processing server 204 may convert monetary values to a common currency or standardize date formats across the dataset.

At 410, the system 200 may address the handling of missing or incomplete data in the tax return. The processing server 204 may employ various techniques to deal with data gaps, such as imputation methods or flagging missing values for later attention. For example, if a taxpayer's occupation is missing, the processing server 204 may use other available information like income sources or industry codes to infer the most likely occupation.

The system 200 may continue processing at 412, where the processing server 204 may organize the data into a structured format. This may involve categorizing different types of income, deductions, and credits according to predefined taxonomies. The structured format may facilitate easier navigation and analysis of the tax return data in subsequent processing stages.

At 414, the system 200 may conclude with preparing the cleaned data for feature extraction. This may involve generating text embeddings for descriptive fields in the tax return data. Text embeddings may convert textual information into numerical vectors, allowing the system to process and analyze text-based data more effectively. For instance, the processing server 204 may generate embeddings for fields like job descriptions or explanations of unusual expenses, enabling more sophisticated analysis of these textual elements in later stages of the tax return processing pipeline.

By following this method 400, the processing server 204 may transform raw tax return data into a clean, structured, and analysis-ready format. This processed data may then be used for feature extraction, machine learning classification, LLM classification, and the generation of a comprehensive tax return taxonomy by processing server 204.

In the context of the accountant processing a complex tax return for a client using the system 100, the process 400 in FIG. 4 may unfold as follows: At 402, the accountant may upload the client's extensive tax return data in JSON format through their laptop (client device 202). At 404, the processing server 204 may validate this complex data structure, ensuring fields for individuals are present and properly formatted. 406 may involve the processing server 204 removing any redundant information, such as duplicate investment entries or irrelevant metadata, from the client's extensive financial records. At 408, the processing server 204 may standardize the various data formats and units present in the client's tax return, potentially converting international investment values to a common currency. At 410, the processing server 204 may handle any missing or incomplete data in the complex return, possibly using sophisticated imputation methods to estimate missing values based on the client's unique financial profile. At 412, the processing server 204 may organize the client's diverse financial data into a structured format, categorizing various income sources, deductions, and credits according to predefined taxonomies suitable for individuals. At 414, the processing server 204 may prepare the cleaned data for feature extraction, generating text embeddings for descriptive fields such as explanations of complex financial transactions or descriptions of unique tax situations often encountered by clients.

At 402, the system may receive tax return data in JSON format, potentially using JSON Schema for validation. At 404 the system may employ schema validation techniques such as JSON Schema Validation or XSD to verify the data structure. For 406, algorithms like deduplication methods (e.g., hash-based or Levenshtein distance) may be used to remove redundant information. At 408 the system may utilize data normalization techniques, such as min-max scaling or z-score normalization, to standardize numerical data, and regular expressions for standardizing date formats. At 410, missing data handling may involve imputation techniques like mean imputation, k-Nearest Neighbors (k-NN) imputation, or multiple imputation by chained equations (MICE). 412 may use data structuring algorithms such as decision trees or hierarchical clustering to organize the data into predefined categories. At 414 the system may employ natural language processing techniques like Word2Vec, GloVe, or BERT to generate text embeddings for descriptive fields, and dimensionality reduction methods such as PCA or t-SNE to prepare numerical features for subsequent analysis.

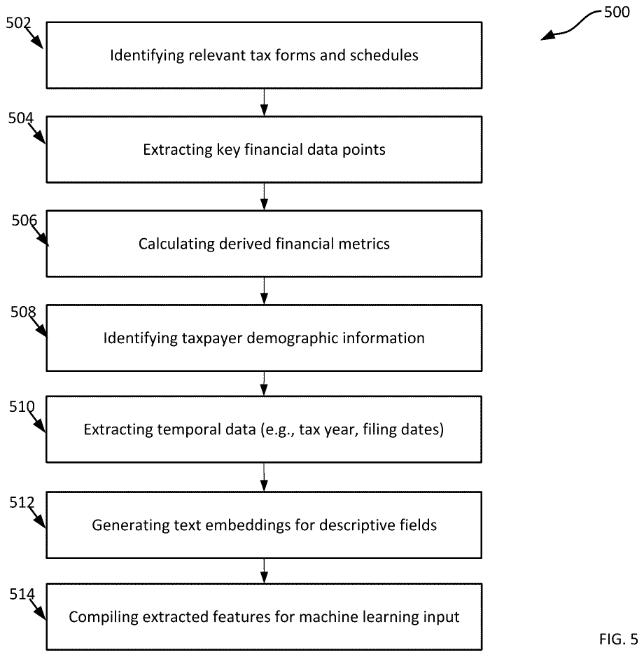

FIG. 5 illustrates a flowchart of a method 500 for feature extraction from tax return data. The method 500 in FIG. 5 may comprise processing performed by system 200 such as identifying relevant tax forms and schedules (502), extracting financial data points (504), calculating derived financial metrics (506), identifying taxpayer demographic information (508), extracting temporal data (510), generating text embeddings for descriptive fields (512), and compiling the extracted features for machine learning input (514).

The system 200 may begin processing at 502 with identifying relevant tax forms and schedules. In some cases, the processing server 106 may analyze the received tax return data to determine which forms and schedules are present and relevant for further processing. For example, the processing server 106 may identify Form 1040 (U.S. Individual Income Tax Return), Schedule A (Itemized Deductions), Schedule C (Profit or Loss from Business), and other applicable forms based on the taxpayer's specific situation.

During 502, the processing server 106 may use pattern recognition techniques to match the structure and content of the received data against known templates of tax forms. In some cases, the processing server 106 may also cross-reference the identified forms with a database of current tax year forms to ensure accuracy and completeness.

At 504, the system 200 may extract financial data points from the identified forms. The processing server 106 may parse through the tax return data to locate and extract specific financial information. This may include items such as total income, adjusted gross income, taxable income, total tax, and various types of deductions and credits.

During the extraction process in 504, the processing server 106 may employ natural language processing techniques to interpret text-based fields and optical character recognition for scanned documents. In some cases, the processing server 106 may also perform data validation checks to ensure the extracted values are within expected ranges and formats.

At 506 the system 200 may calculate derived financial metrics based on the extracted data points. The processing server 106 may perform various calculations to generate additional insights from the raw tax data. For example, the processing server 106 may calculate ratios such as the effective tax rate, debt-to-income ratio, or the percentage of income allocated to specific deduction categories.

In some cases, at 506, the processing server 106 may use predefined formulas stored in the database 108 to ensure consistency in metric calculations across different tax returns. The processing server 106 may also flag any unusual or outlier values for further review.

At 508, the system 200 may identify taxpayer demographic information. The processing server 106 may extract relevant personal details such as age, marital status, number of dependents, and occupation. This demographic information may provide context for the financial data and may be used in subsequent analysis steps.

At 508, the processing server 106 may employ data anonymization techniques to protect sensitive personal information while still retaining the relevant demographic characteristics for analysis. In some cases, the processing server 106 may also categorize the taxpayer into predefined demographic segments based on the extracted information.

At 510 the system 200 may extract temporal data, including tax year and filing dates. The processing server 106 may identify and extract dates from the tax return, such as the tax year, filing deadline, and any relevant dates for specific income or deduction events.

In some cases, at 510, the processing server 106 may cross-reference the extracted dates with a database of historical tax deadlines and regulations to ensure accuracy and identify any potential issues with late filings or amended returns.

At 512, the system 200 may proceed to generating text embeddings for descriptive fields within the tax return. The processing server 106 may use natural language processing techniques to convert text-based information, such as descriptions of business expenses or explanations for unusual deductions, into numerical vector representations.

At 512, the processing server 106 may employ pre-trained word embedding models, such as Word2Vec or GloVe, to generate these vector representations. In some cases, the processing server 106 may fine-tune these models on a corpus of tax-specific language to improve the relevance of the generated embeddings.

At 514, the system 200 may compile the extracted features for machine learning input. The processing server 106 may organize the extracted and derived data into a structured format suitable for input into machine learning models.

In some cases, at 514, the processing server 106 may perform feature scaling and normalization to ensure input features are on a comparable scale. The processing server 106 may also generate a feature metadata file that describes the meaning and origin of each compiled feature, which may be useful for model interpretability in subsequent analysis steps.

In the context of an accountant using the system 100 to process a complex tax return for a client, the processing in FIG. 5 may unfold as follows: At 502, the processing server 106 may identify a wide array of relevant tax forms and schedules specific to individuals, such as Form 1040, multiple Schedule K-1s for partnership income, and Form 8938 for foreign asset reporting. In 504, the system may extract financial data points from these forms, including various income sources, complex deductions, and international investments. At 506, processing may involve calculating derived financial metrics tailored to clients, such as effective tax rates across different income types or the proportion of income from passive versus active sources. At 508, the system may identify and anonymize sensitive demographic information about the client, potentially categorizing them into specific wealth brackets or investor profiles. At 510, the system may extract temporal data, paying particular attention to dates related to complex transactions or multi-year tax strategies often employed by wealthy clients. At 512, the system may generate text embeddings for descriptive fields, which may be especially valuable for interpreting complex financial instruments or unique tax situations common in returns. At 514, the processing server 106 may compile these extracted features, creating a comprehensive and structured dataset that captures the intricate financial landscape of the client, ready for advanced machine learning analysis.

At 502, the processing server 106 may use pattern matching algorithms like regular expressions or more advanced techniques such as convolutional neural networks (CNNs) for form identification. For 504, natural language processing (NLP) techniques such as named entity recognition (NER) or rule-based extraction may be employed to extract financial data points. At 506, statistical methods like linear regression or more complex algorithms such as gradient boosting machines may be used to calculate derived financial metrics. At 508, the system may utilize machine learning classification algorithms such as random forests or SVMs to categorize demographic information. For 510, time series analysis techniques like ARIMA or Prophet may be used to extract and analyze temporal data. At 512, the system may employ word embedding techniques such as Word2Vec, GloVe, or BERT to generate vector representations of textual data. At 514, feature selection algorithms like Lasso or elastic net may be used to compile the relevant features, while techniques such as min-max scaling or z-score normalization may be applied for feature scaling and normalization.

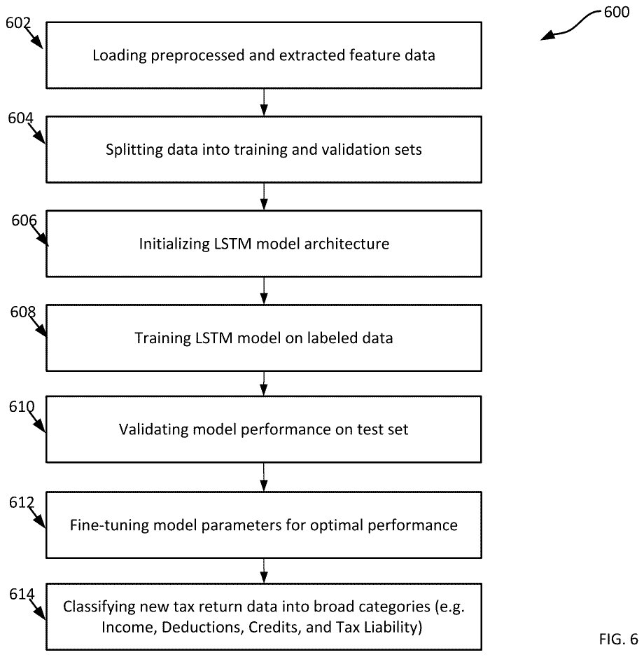

FIG. 6 illustrates a flowchart of a method 600 for machine learning classification of tax return data. The method 600 in FIG. 6 may comprise processing performed by system 200 such as loading preprocessed and extracted feature data (602), splitting data into training and validation sets (604), initializing an LSTM model architecture (606), training the LSTM model on labeled data (608), validating model performance on a test set (610), fine-tuning model parameters for optimal performance (612), and classifying new tax return data into broad categories (614).

At 602, the system 200 may begin with loading preprocessed and extracted feature data. In some cases, the processing server 106 may retrieve the preprocessed tax return data from the database 108 via the communication network 110. This data may have already undergone initial cleaning and feature extraction processes, making the data suitable for machine learning analysis.

The system 200 may continue processing at 604, where the processing server 106 may split the data into training and validation sets. This may be beneficial for ensuring that the machine learning model can be properly trained and evaluated. The training set may be used to teach the model how to classify tax return data, while the validation set may be used to assess the model's performance on unseen data.

At 606, the system 200 may initialize a LSTM model architecture. LSTM may be a type of recurrent neural network that may be particularly well-suited for processing sequential data, such as the various entries in a tax return. The processing server 106 may set up the LSTM network with appropriate layers and parameters for tax return classification tasks.

The system 200 may proceed to 608, where the processing server 106 may train the LSTM model on labeled data. During this step, the model may learn to recognize patterns and relationships in the tax return data that correspond to different categories. For example, the model may learn to associate certain types of income or deduction entries with specific tax categories.

At 610, the system 200 may validate the model performance on a test set. The processing server 106 may use a separate set of labeled tax return data that the model has not seen during training to evaluate its classification accuracy. This may help ensure that the model can generalize well to new, unseen tax returns and is not overfitting to the training data.

The system 200 may continue processing at 612, where the processing server 106 may fine-tune the model parameters for optimal performance. Based on the results of the validation step, the processing server 106 may adjust various aspects of the LSTM model, such as the learning rate, number of hidden layers, or regularization techniques, to improve its classification accuracy.

At 614, the system 200 may conclude processing with classifying new tax return data into broad categories. Once the LSTM model has been trained and optimized, the processing server 106 may use the model to categorize new, unseen tax return data into broad categories such as Income, Deductions, Credits, and Tax Liability. This classified data may then be combined with the classification output by the LLM server 104 for further analysis and taxonomy generation.

By following this method 600, the processing server 106 may transform raw tax return data into classified information ready for advanced analysis. The use of an LSTM neural network may allow for sophisticated pattern recognition in complex tax data, potentially improving the accuracy and efficiency of tax return processing compared to traditional rule-based systems.

In the context of an accountant using the system 100 to process a complex tax return for a client, the process 600 in FIG. 6 may unfold as follows: At 602, the processing server 106 may load the preprocessed and extracted feature data from the client's tax return, which may include a wide array of financial information such as multiple income sources, complex deductions, and international investments. At 604, this data may be split into training and validation sets, ensuring that the model can learn from a diverse range of high-value tax scenarios. At 606, processing may involve initializing an LSTM model architecture specifically designed to handle the intricacies of tax returns, with layers capable of processing long sequences of financial data. At 608, the LSTM model may be trained on labeled data from similar tax returns, learning to recognize patterns specific to wealthy individuals' financial situations. At 610, the model's performance may be validated using a test set of complex tax returns, ensuring its accuracy in classifying sophisticated financial structures. At 612, processing may involve fine-tuning the model parameters to optimize its performance on tax returns, potentially adjusting for factors like international tax considerations or complex investment structures. At 614, the trained and optimized LSTM model may classify the new client's tax return data into broad categories, providing the accountant with a sophisticated initial analysis of the client's complex financial situation, ready for further examination and refinement.

At 602, the system may load preprocessed data in formats such as CSV, JSON, or parquet files, potentially using libraries like pandas or Apache Arrow for efficient data handling. For 604, techniques such as stratified sampling or time-based splitting may be employed to create representative training and validation sets. At 606, processing may involve initializing an LSTM architecture using deep learning frameworks like TensorFlow or PyTorch, potentially incorporating attention mechanisms or bidirectional LSTM layers. At 608, the model may be trained using techniques such as mini-batch gradient descent, Adam optimizer, or learning rate scheduling, with potential use of techniques like dropout or batch normalization for regularization. At 610, the system may utilize evaluation metrics such as accuracy, F1-score, or area under the ROC curve to assess model performance on the test set. For 612, hyperparameter tuning techniques like grid search, random search, or Bayesian optimization may be employed to fine-tune the model. At 614, the trained LSTM model may use softmax activation for multi-class classification, potentially incorporating techniques like ensemble learning or model distillation for improved performance on new tax return data.

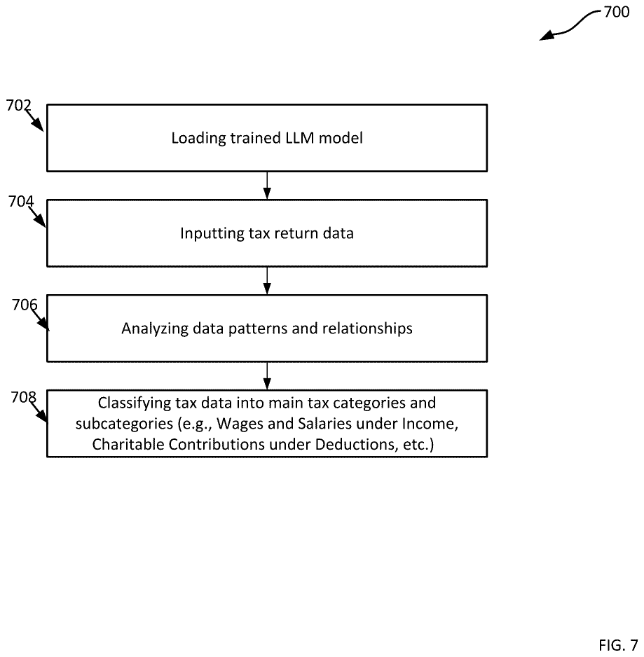

FIG. 7 illustrates a flowchart of a method 700 for analyzing tax return data and generating a taxonomy using an LLM. The method 700 in FIG. 7 may comprise processing performed by system 200 such as loading a trained LLM model (702), inputting tax return data into the loaded model (704), analyzing data patterns and relationships within the tax return data (706), and identifying subcategories within main tax categories (708).

The system 200 may begin processing at 702 with loading a trained LLM model. In some cases, the LLM server 104 may load a pre-trained language model that has been fine-tuned on tax-specific data. This model may be capable of understanding complex tax regulations and applying them to specific tax situations.

At 702, the LLM server 104 may initialize the model parameters and load supporting data, such as tax code references or historical tax return patterns. In some cases, the LLM server 104 may also perform a quick validation check to ensure the model is functioning correctly before proceeding with the analysis.

At 704, the system 200 may input tax return data into the loaded model. The LLM server 104 may receive the preprocessed data from the processing server 106 via the communication network 110. This data may include extracted features and calculated financial metrics among others.

At 704, the LLM server 104 may format the input data to match the expected input structure of the LLM. In some cases, this may involve tokenizing text data, encoding numerical values, or structuring the data into a specific sequence format that the LLM can process effectively.

At 706, the system 200 may analyze data patterns and relationships within the tax return data. The LLM server 104 may process the input data, leveraging its training on tax-specific information to identify complex patterns and relationships that may not be immediately apparent through traditional analysis methods.

At 706, the LLM server 104 may employ various natural language processing techniques, such as semantic analysis and contextual understanding, to interpret the tax return data. In some cases, the LLM server 104 may also use attention mechanisms to focus on particularly relevant aspects of the input data, allowing for more nuanced analysis of complex tax situations.

At 708, the system 200 may proceed to identifying subcategories within main tax categories. The LLM server 104 may classify the analyzed data into broad categories such as Income, Deductions, Credits, and Tax Liability. Within each of these main categories, the LLM server 104 may further identify and classify various subcategories.

At 708, the LLM server 104 may use its understanding of tax regulations to create a detailed categorization structure. For example, within the Income category, the LLM server 104 may identify subcategories such as Wages and Salaries, Business Income, Investment Income, and Rental Income. Similarly, within the Deductions category, subcategories may include Charitable Contributions, Mortgage Interest, and Medical Expenses.

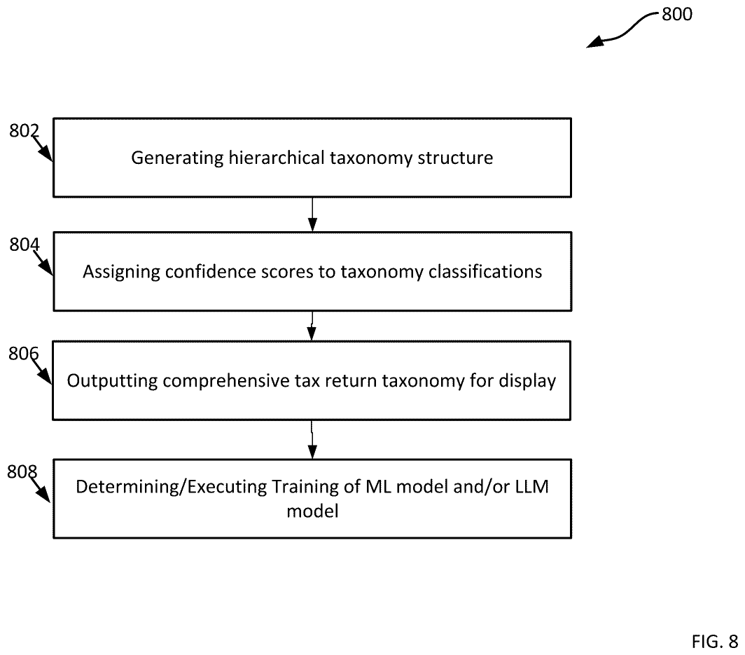

FIG. 8 illustrates a flowchart of a method 800 for analyzing the classifications from the ML model and LLM and generating a taxonomy. The method 800 in FIG. 8 may comprise processing performed by system 200 such as generating a hierarchical taxonomy structure (802), assigning confidence scores to the taxonomy classifications (804), outputting the comprehensive tax return taxonomy for display (806) and determining/executing training of the ML model and/or the LLM.

As described below, method 800 may involve generating a hierarchical taxonomy structure (802) based on the outputs from both the ML model (FIG. 6) and the LLM (FIG. 7). The system may combine these outputs, potentially weighting them based on their respective confidence scores or the specific aspects of the tax return being analyzed. This approach may result in a more robust and accurate categorization of tax return elements. The method 800 may then assign confidence scores to the taxonomy classifications (804), which may help identify areas that require additional review or documentation. The comprehensive tax return taxonomy may then be output for display (806), providing users with a sophisticated overview of the tax return structure.

The method 800 may also incorporate a feedback loop mechanism to continuously improve the performance of both the ML and LLM models. After generating the taxonomy, the system may analyze the outputs of both models along with their associated confidence scores. Based on this assessment, the system may determine which model, if any, may benefit from additional training to improve accuracy (808). Feedback may then be provided to one or both models for updates. This ongoing refinement process may allow the system to adapt to new tax regulations, evolving financial instruments, and changing patterns in tax return data, potentially leading to increasingly accurate and insightful analyses over time while optimizing computational resource allocation.

Specifically, at 802, system 200 processing may involve generating a hierarchical taxonomy structure based on the identified categories and subcategories from both the ML model and the LLM. The processing server 106 may organize the analyzed tax return data into a tree-like structure, with main categories at the top level and increasingly specific subcategories at lower levels.

At 802, the processing server 106 may employ various algorithms to optimize the structure of the taxonomy. In some cases, the processing server 106 may use techniques such as hierarchical clustering or decision tree algorithms to create a logical and intuitive taxonomy structure. The processing server 106 may also cross-reference the generated taxonomy against IRS tax code for validation, ensuring that the structure aligns with current tax regulations.

At 804, the system 200 may assign confidence scores to the taxonomy classifications. The processing server 106 may evaluate the certainty of each classification decision and assign a numerical score representing the confidence level of that classification.

At 804, the processing server 106 may use various statistical and probabilistic methods to calculate these confidence scores. In some cases, the processing server 106 may consider factors such as the amount of supporting evidence in the tax return data, the consistency of the classification with known tax rules, and the historical accuracy of similar classifications. These confidence scores may help tax professionals identify areas that may require additional review or documentation.

At 806, system 200 processing may involve outputting a comprehensive tax return taxonomy for display. The processing server 106 may prepare the generated taxonomy, including the hierarchical structure and associated confidence scores, for transmission back to the client device 102 via the communication network 110.

At 806, the processing server 106 may format the taxonomy data for optimal display and interaction on the client device 102. In some cases, the processing server 106 may use nucleus sampling for output diversity when generating the final taxonomy structure, ensuring a balance between consistency and variety in the presented information. The processing server 106 may also generate metadata or annotations to accompany the taxonomy, providing additional context or explanations for specific classifications.

At 808, the system 200 may determine which model, if any, may benefit from additional training to improve accuracy. The processing server 106 may analyze the outputs of both the ML model and the LLM along with their associated confidence scores. Based on this assessment, feedback may be provided to one or both models for purposes of updates. This ongoing refinement process may allow the system to adapt to new tax regulations, evolving financial instruments, and changing patterns in tax return data, potentially leading to increasingly accurate analyses over time.

In the context of an accountant using the system 100 to process a complex tax return for a client, processes 700 and 800 in FIGS. 7 and 8 may unfold as follows: At 702, the LLM server 104 may load a pre-trained model specifically fine-tuned on tax scenarios. At 704, the system may input the client's classified tax data, including complex financial structures and international investments. At 706, the LLM may analyze intricate patterns within the client's data, potentially identifying sophisticated tax strategies or unusual income sources. At 708, the LLM may identify detailed subcategories tailored to individuals, such as various types of capital gains or specialized deductions. At 802, the system may generate a hierarchical taxonomy that effectively organizes the client's complex financial situation, potentially grouping related investments or business entities. At 804, system processing may involve assigning confidence scores to each classification, which may be particularly useful for identifying areas of the client's return that require additional scrutiny or documentation. At 806, the system may output a comprehensive taxonomy of the client's tax return, providing the accountant with a sophisticated overview of the client's financial situation, complete with confidence scores and potential areas of focus for further analysis or tax optimization strategies. At 808, the system may provide feedback for updating one or both models based on the model outputs and the confidence scores.

At 702, the LLM server may load pre-trained models such as GPT-3, BERT, or T5, potentially using techniques like transfer learning or fine-tuning on tax-specific datasets. For 704, the system may use data serialization formats like Protocol Buffers or Apache Avro to efficiently input classified tax data. At 706, the LLM may employ advanced NLP techniques such as named entity recognition, sentiment analysis, or topic modeling to analyze patterns in the tax data. At 708, the system may utilize hierarchical clustering algorithms like HDBSCAN or agglomerative clustering to identify subcategories. For 802, the system may use graph algorithms like PageRank or HITS to generate the hierarchical taxonomy structure. At 804, the system may employ Bayesian inference or Monte Carlo methods to assign confidence scores to classifications. At 806, the system may use data visualization libraries such as D3.js or Plotly to create interactive, hierarchical visualizations of the generated taxonomy, potentially employing WebGL for handling large datasets efficiently.

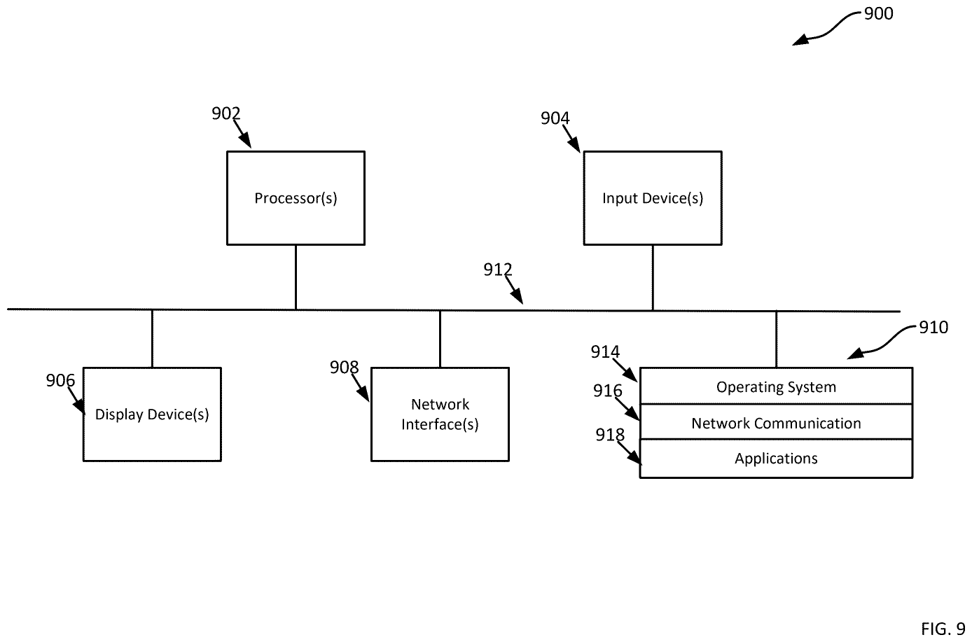

FIG. 9 illustrates a block diagram of a computing system 900. The computing system 900 may be used to implement various components of the system 100, such as the client device 102, the LLM server 104, or the processing server 106. The computing system 900 may include a processor(s) 902, input device(s) 904, display device(s) 906, network interface(s) 908, a software stack 910, and a system bus 912.

The processor(s) 902 may execute instructions and process data for the computing system 900. In some cases, the processor(s) 902 may include multiple cores or may comprise multiple separate processors working in parallel. The input device(s) 904 may allow data entry into the computing system 900. For example, when the computing system 900 is used as the client device 102, the input device(s) 904 may include a keyboard, mouse, or touchscreen for entering tax return data or navigating the interactive interface.

The display device(s) 906 may provide visual output for the computing system 900. In some cases, when the computing system 900 is used as the client device 102, the display device(s) 906 may present the interactive interface that facilitates navigation through the hierarchical taxonomy of the tax return data. The interactive interface may allow viewing of details of specific tax return elements, enabling users to explore different categories and subcategories of the tax information.

The network interface(s) 908 may enable communication with external networks and devices. For example, when the computing system 900 is used as the processing server 106, the network interface(s) 908 may facilitate communication with the client device 102, the LLM server 104, and the database 108 through the communication network 110.

The software stack 910 may include multiple layers that work together to provide the functionality of the computing system 900. The software stack 910 may include an operating system layer 914, a communication layer 916, and an application layer 918. The operating system layer 914 may manage hardware resources and provide basic system services. The communication layer 916 may handle network communication functions, facilitating data exchange between components of the system 100. The application layer 918 may contain software applications that run on the computing system 900, such as the tax return processing software or the interactive interface for displaying the generated taxonomy.

The system bus 912 may connect components of the computing system 900 and facilitate data transfer between the hardware components and the software stack 910. This architecture may allow for efficient communication and data flow between components of the computing system 900, enabling seamless operation of the system 100.

In some cases, when the computing system 900 is used as the client device 102, the application layer 918 may include functionality that allows user feedback and corrections to improve the system. For example, an accountant using the interactive interface may identify a misclassification in the generated taxonomy. The application layer 918 may provide a mechanism for the accountant to correct this classification, and this feedback may be sent back to the processing server 106 and the LLM server 104 to improve future classifications and analyses.

The interactive interface presented on the display device(s) 906 may facilitate navigation through the hierarchical taxonomy of the tax return data. Users may be able to expand or collapse different categories, drill down into specific subcategories, and view detailed information about individual tax return elements. For instance, an accountant may start at the top-level categories such as Income, Deductions, Credits, and Tax Liability, and then drill down into specific subcategories like Wages and Salaries under Income or Charitable Contributions under Deductions.

In addition to navigation, the interactive interface may allow viewing of details of specific tax return elements. For example, when an accountant selects a particular deduction, the interface may display relevant information such as the amount, date, and any supporting documentation associated with that deduction. This detailed view may help accountants quickly assess the validity and completeness of each tax return element.

By combining easy navigation with detailed element views, the interactive interface may significantly enhance the efficiency of tax return analysis. Accountants may be able to quickly identify areas that require attention, verify the accuracy of classifications, and ensure relevant information has been properly captured and categorized.

While the foregoing is directed to example embodiments described herein, other and further example embodiments may be devised without departing from the basic scope thereof. For example, aspects of the present disclosure (e.g., modules) may be implemented in hardware or software or a combination of hardware and software. One example embodiment described herein may be implemented as a program product for use with a computer system. The program(s) of the program product defines functions of the example embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid-state random-access memory) on which alterable information is stored. Such computer-readable storage media, when carrying computer-readable instructions that direct the functions of the disclosed example embodiments, are example embodiments of the present disclosure.

It will be appreciated by those skilled in the art that the preceding examples are not limiting. It is intended that permutations, enhancements, equivalents, and improvements thereto are apparent to those skilled in the art upon a reading of the specification and a study of the drawings are included within the true spirit and scope of the present disclosure. It is therefore intended that the following appended claims include such modifications, permutations, and equivalents as fall within the true spirit and scope of these teachings.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A method for processing tax return data, comprising:
receiving, by a processing server, tax return data in a structured format comprising a schema defining the tax return data;
extracting, by the processing server, features from the tax return data according to the schema;
classifying, by the processing server, the extracted features using a machine learning model based on historical tax return patterns;
classifying, in parallel with the machine learning model, by a large language model (LLM), the extracted features based on contextual understanding;
analyzing, by an engine, the classified data from the machine learning model and the LLM to generate a hierarchical taxonomy of the tax return data sorted into categories and subcategories, wherein the engine selects between outputs of the machine learning model and the LLM based on confidence scores and a data type of the extracted features, the engine weighting the machine learning model output for structured numerical data and weighting the LLM output for unstructured textual data;
analyzing, by the LLM, the hierarchical taxonomy of the tax return data;
displaying, by a display device, the generated taxonomy to a user through an interactive interface; and
training, based on the confidence scores, one or more of the machine learning model and the LLM via a feedback loop.

2. The method of claim 1, wherein the structured format of the tax return data is JavaScript Object Notation (JSON).

3. The method of claim 1, wherein preprocessing the tax return data further comprises:
validating, by the processing server, the data structure and the schema of the received tax return data; and
processing, by the processing server, missing or incomplete data in the tax return.

4. The method of claim 1, wherein extracting relevant features comprises:
identifying, by the processing server, relevant tax forms and schedules;
extracting, by the processing server, key financial data points; and
calculating, by the processing server, derived financial metrics.

5. The method of claim 4, further comprising:
identifying, by the processing server, taxpayer demographic information; and
extracting, by the processing server, temporal data including tax year and filing dates.

6. The method of claim 1, wherein the machine learning model is a Long Short-Term Memory (LSTM) neural network.

7. The method of claim 6, further comprising:
training the LSTM neural network on a dataset of labeled tax return data; and
validating the trained LSTM model's performance on a test dataset.

8. The method of claim 1, wherein the tax categories comprise Income, Deductions, Credits, and Tax Liability, and each of the tax categories comprise a plurality of subcategories.

9. The method of claim 1, wherein generating the hierarchical taxonomy comprises:
assigning, confidence scores to the classified data and using the confidence scores to train one or more of the machine learning model and LLM.

10. The method of claim 9, wherein the interactive interface facilitates navigation through the hierarchical taxonomy and viewing of details of specific tax return elements.

11. A system for processing tax return data, comprising:
a processing server configured to:
receive tax return data in a structured format comprising a schema defining the tax return data;
extract features from the tax return data according to the schema;
classify the extracted features using a machine learning model based on historical tax return patterns;
classify, in parallel with the machine learning model, by a large language model (LLM), the extracted features based on contextual understanding;
analyze, by an engine, the classified data from the machine learning model and the LLM to generate a hierarchical taxonomy of the tax return data sorted into categories and subcategories, wherein the engine selects between outputs of the machine learning model and the LLM based on confidence scores and a data type of the extracted features, the engine weighting the machine learning model output for structured numerical data and weighting the LLM output for unstructured textual data;
analyze the hierarchical taxonomy of the tax return data;
train, based on the confidence scores, one or more of the machine learning model and the LLM via a feedback loop; and
a display device configured to display the generated taxonomy to a user through an interactive interface.

12. The system of claim 11, wherein the structured format of the tax return data is JavaScript Object Notation (JSON).

13. The system of claim 11, wherein the processing server is further configured to:
validate the data structure and the schema of the received tax return data; and
process missing or incomplete data in the tax return.

14. The system of claim 11, wherein the processing server is further configured to:
identify relevant tax forms and schedules;
extract key financial data points; and
calculate derived financial metrics.

15. The system of claim 14, wherein the processing server is further configured to:
identify taxpayer demographic information; and
extract temporal data including tax year and filing dates.

16. The system of claim 11, wherein the machine learning model is a Long Short-Term Memory (LSTM) neural network.

17. The system of claim 16, wherein the processing server is further configured to:
train the LSTM neural network on a dataset of labeled tax return data; and
validate the trained LSTM model's performance on a test dataset.

18. The system of claim 11, wherein the tax categories comprise Income, Deductions, Credits, and Tax Liability, and each of the tax categories comprise a plurality of subcategories.

19. The system of claim 11, wherein the processing server is further configured to:
assign confidence scores to the classified data when generating the hierarchical taxonomy and using the confidence scores to train one or more of the machine learning model and LLM.

20. The system of claim 19, wherein the interactive interface facilitates navigation through the hierarchical taxonomy and viewing of details of specific tax return elements.
